(19) United States
(12) Patent Application Publication
(10) Pub. No.: US 2001/0056389 A1
(43) Pub. Date: Dec. 27, 2001

(54) Network chat with integrated billing

(76) Inventors: Robert W. Fair, Santa Ana, CA (US); Geoffrey S. Works, Huntington Beach, CA (US); John C. Lautsch, Orange, CA (US); Neal E. Weisman, Santa Ana, CA (US); Subramanyan Ramesh, Redondo Beach, CA (US); Christopher B. Smith, Los Angeles, CA (US); John Sarkela, Ventura, CA (US); David L. Caster, Ventura, CA (US); John Christopherson, Santa Ana, CA (US)

Correspondence Address: STRADLING YOCCA CARLSON & RAUTH, IP Department, Suite 1600, 660 Newport Center Drive, P.O. Box 7680, Newport Beach, CA, 92660-6441, US

(21) Appl. No.: 09/820,271

(22) Filed: Mar. 27, 2001

Related U.S. Application Data
(60) Provisional application No. 60/192,208, filed on Mar. 27, 2000.

(51) Int. Cl. G06F 17/60

(52) U.S. Cl. 705/34; 705/40

(57) ABSTRACT

A method for facilitating negotiated fee-based billable communication on a network that is comprised of forming a business relationship between a third party and a plurality of business service providers, facilitating communication between the business service providers and clients of the business service providers via the network, facilitating real-time negotiation between the business service providers and the clients for a flat or time-based communication fee and facilitating automatic billing of the client and automatic payment of the business service provider for a billable communication session.

### PRIORITY CLAIM

This patent application claims the benefit of the filing date of United States Provisional Patent Application Serial No. 60/192,208, filed Mar. 27, 2000 and entitled NETWORK CHAT WITH INTEGRATED BILLING, the entire contents of which are hereby expressly incorporated by reference.

### FIELD OF THE INVENTION

The present invention relates generally to network communications and relates more particularly to a method for facilitating real-time negotiated fee-based communication on a network.

### BACKGROUND OF THE INVENTION

On-line chat systems whereby participants communicate with one another via a network, typically the Internet, are well known. Examples of such chat systems include America Online (AOL) chat rooms, American Online Instant Messaging, and MicroSoft Instant Messaging (Aim, MSN, ICQ, etc.) Generally, such on-line chat systems facilitate communication via text messaging. However, audio and video messaging systems are also known.

Such contemporary messaging systems are typically utilized in a peer-to-peer capacity. Although such contemporary on-line messaging systems may be utilized for fee-based consulting, such contemporary messaging systems suffer from inherent deficiencies which detract from their overall effectiveness and desirability.

Contemporary on-line messaging systems lack a means for facilitating negotiation of a billing rate, a means for recording and displaying the current amount billed, a means for renegotiating a new rate if the terms change, a means for automatically billing the client and the business service provider (BSP), and a means for easily accommodating value added services which include, but are not limited to audio, video, multi-party conferencing, file transfer, language translation, currency conversion, and co-browsing. Further, contemporary on-line messaging systems typically require some commonality of equipment and protocol. For example, generally on-line messaging systems require that both users have a computer and that both participants utilize the same, if any, security protocol.

In view of the foregoing, it is desirable to provide an on-line communication or messaging system which facilitates negotiated fee-based communication by providing the ability to conveniently negotiate and/or renegotiate a billing rate, which displays the current amount billed to one or both parties, and which facilitates the easy use of value-added services . It would further be beneficial to provide such a system wherein participants may utilize diverse devices, including non-computer devices such as cellular telephones, pagers, wireless Internet access devices, Internet appliances and satellite network devices, kiosk's, portable medical monitoring and tracking devices, and other network-enabled portable electronic devices.

### SUMMARY OF THE INVENTION

The present invention specifically addresses and alleviates the above-mentioned deficiencies associated with the prior art. More particularly, the present invention comprises a method for a third party to facilitate fee-based billable communication on a network (such as the Internet). The method comprises forming a business relationship between the third party and a plurality of business service providers (BSPs), facilitating communication between the business service providers and clients of the business service providers via the network, facilitating negotiation between the business service providers and the clients for a negotiated, flat or time-based consulting fee, and facilitating automatic billing to the client by the business service provider and/or payment by the client to the business service provider and also facilitates automatic billing to the business service provider by the third party and/or payment by the business service provider to the third party.

These, as well as other advantages of the present invention will be more apparent from the following description and drawings. It is understood that changes in the specific structure shown and described may be made within the scope of the claims without departing from the spirit of the invention.

### BRIEF DESCRIPTION OF THE DRAWINGS

These, and other features, aspects and advantages of the present invention will be more fully understood when considered with respect to the following detailed description, appended claims and accompanying drawings, wherein:

FIG. 1 is a flow chart showing the business service provider (BSP) sign up process;

FIG. 2 is a flow chart showing the client sign up process;

FIG. 3 is a flow chart showing the existing merchant account verification process;

FIG. 4 is a flow chart showing the business service provider (BSP) profile entering process;

FIG. 5 is a flow chart showing the business service provider (BSP) account activation process;

FIG. 6 is a flow chart showing the business service provider (BSP) log in process;

FIG. 7 is a flow chart showing the client log in process;

FIG. 8 is a flow chart showing the business service provider (BSP) deposit account validation process;

FIG. 9 is a flow chart showing the convergence layer which facilitates interoperability of protocols and devices between clients and business service providers;

FIG. 10 is a flow chart showing the negotiation session initiation request process;

FIG. 11 is a flow chart showing the negotiation session acceptance process;

FIG. 12 is a flow chart showing a first portion of the negotiation session process;

FIG. 13 is a flow chart showing a second portion of the negotiation session process;

FIG. 14 is a flow chart showing the negotiation session process overview;

FIG. 15 is a flow chart showing the billing session process overview;

FIG. 16 is a flow chart showing the value-added service request process;

FIG. 17 is a flow chart showing the negotiated rate amendment process;

FIG. 18 is a flow chart showing a first portion of the end billing session process; and

FIG. 19 is a flow chart showing a second portion of the end billing session process.

### DETAILED DESCRIPTION OF THE INVENTION

The detailed description set forth below in connection with the amended drawings is intended as a description of the presently preferred embodiment of the invention, and is not intended to represent the only form in which the present invention may be constructed or utilized. The detailed description sets forth the construction and functions of the invention, as well as the sequence of steps for operating the invention in connection with the illustrated embodiment. It is to be understood, however, that the same or equivalent functions may be accomplished by different embodiments that are also intended to be encompassed within the spirit and scope of the invention.

PremiumChat Verbal Description for Patent Agent

The present invention changes the way business service providers communicate with their clients. The present invention provides business service providers with a new means of conducting business via global distributed networks. The present invention is a system and method for knowledge providers (teachers, computer professionals, accountants, lawyers, real estate agents, etc.) to make money with their knowledge, expertise, service twenty-four hours a day. A core goal of the project is to enable present office-bound business service providers to migrate to the system of global distributed networks with their services. The method of doing this is to provide a system that provides one-on-one secure communication between the business service providers and a client, which system is connected to a surrounding constellation of support features useful to both the business service provider and the client. This system is occasionally referred to herein as PremiumChat or the Company and is provided by a third party with respect to the users (the Business Service Providers and the Clients).

PremiumChat is a computerized communications system used to link information and knowledge providers (“business service providers”) together point-to-point (preferably no host pass-through (sometimes called peer-to-peer)) to clients over the system of global computer networks by means of a secure system which is surrounded by a large cluster of readily-available electronic features. The features include time-and-billing, real-time language translation, document translation, chat translation, guaranteed identity matching, file transfer during chat point to point, sign and encrypt, lock, client feedback regarding business service provider, billing history, account status, messaging. The system consists of a backbone of third party equipment, the system of global computer networks, the PremiumChat system (i.e., software), and its constellation of features, some of which are located on Web sites.

A client preferably downloads from a Web site (or install from a local copy) the PremiumChat system. If the client did not already have a business service provider who used the system, he or she would then visit the main Company Web site and proceed to search for a business service provider in the desired field. He would be able to use multiple search options, including but not limited to Boolean and Verity, to better locate his desired business service provider. To enable the client to make a sound selection of whom he would want to select, a feedback system (feature) is accessible to review other clients' experiences with the business service provider.

Once the client makes a decision on whom he or she would like to contact, he would click a link that would launch the PremiumChat system and the chosen professional would be contacted. Language options are set at this point if the session will take place between people of different languages. If the business service provider was online and available to chat, a rate negotiation would begin. This is the opportunity for the business service provider and the client to reach a meeting of the minds over the price for services and/or product(s). Once a rate is agreed upon, the business service provider and client would enter into the billing session. This session may be a flat or timed rate for billing purposes.

The entire conversation (provided it is in the same language) transmits directly between the client and business service provider and does not pass through the Company's systems. This feature is to enhance security. The host system never sees nor records the chat session. “Hello” packets (very small packets of data) are sent from the client to the host system to signal the host that the session is active.

During the billing session, the client can send files via a file transfer protocol to the business service provider in several ways. Files can be transferred unencrypted, encrypted with several levels of security (based on a public/private key system): basic encrypt, sign and encrypt, and locked. The billing session itself can also be encrypted based on a public/private key system. (This is a sign and encrypt method.)

At the end of the billing session, the client account (credit card on file and/or other verifiable payment mechanisms) is billed directly to BSP's merchant account. Receipts are generated for both the business service provider and the end user. There are a myriad of personal preferences that can be set to detail how and when receipts are printing.

A business service provider desiring to do business over the global computer networks by sharing his or her expertise would download from a Company Web site (or install from a local copy) the Premium Chat system. After the system was successfully installed, he would be prompted to register. This process consists of applying for a merchant account or another method of collection of money (third party processor). Thereafter, he would be prompted to enter his own billing information and a deposit would be charged to his credit card (each billing session would deduct $1.00 (or other amount as determined by Company) from his deposit account balance and this is the fee for using the system). After his account was set up, he would log onto the global computer network and set his store to “open”, after which potential clients could contact him to initiate business chat systems.

More frequently, it is envisioned that established business service providers seeking to move their practices from merely brick-and-mortar based consulting would use the PremiumChat system to deal with their existing client base. In this method, if a business service provider desired professional assistance in the course of providing services to a client, say from an appraiser or another business service provider, he would use the cluster of Web sites associated with the PremiumChat system to locate such assistance.

Once a client makes contact with a business service provider, a rate negotiation would commence, unless the-client were already doing business with the business service provider. For new clients, after a desired negotiated rate was agreed upon, the billing session would begin.

The entire conversation (provided it is in the same language) transmits directly between the client and the business service provider and does not pass through the host systems. This is a security feature. The host system never sees nor records the chat session. “Hello” packets are sent from the client to the host system to signal the host that the session is still active.

At the end of the business chat session, the client account (credit card on file and/or other payment mechanisms) is billed directly to BSP's merchant account. Receipts are generated for both the business service provider and the end user. There are a myriad of personal preferences that can be set to detail how and when receipts are printing.

PremiumChat is (1) the first chat system dedicated to business usage and that (2) comes embedded in constellation of useful features for business service providers. The features, especially the architecture of Web sites providing support services and goods, are novel.

The present invention comprises a method for a third party to facilitate negotiated fee-based billed communication on a network. The method comprises forming a business relationship between the third party and a plurality of business service providers, facilitating “real-time” communication between the business service providers and clients of the business service providers via the network, facilitating negotiation between the business service providers and the clients for a flat or time-based consulting fee, and facilitating automatic billing of the client and automatic payment of the business service provider for services rendered and/or product(s) delivered.

Although business service providers would generally provide services and/or products, as defined herein business service providers include any entities capable of providing any service and/or product(s) via the a network for which a client may be billed. Further, as used herein, PremiumChat is the third party who facilitates negotiated fee-based communication on a network, such as the Internet.

Forming a business relationship between the third party and a plurality of business service providers preferably comprises the business service provider providing money which is deposited into a deposit account and from which the money can be removed by the third party so as to facilitate payment to the third party for the third party's facilitating the negotiated fee-based communication.

Facilitating communication between the business service providers and the client preferably comprises facilitating communication on the Internet. However, those skilled in the art will appreciate that various other networks, such as intranets and WANs, likewise suitable.

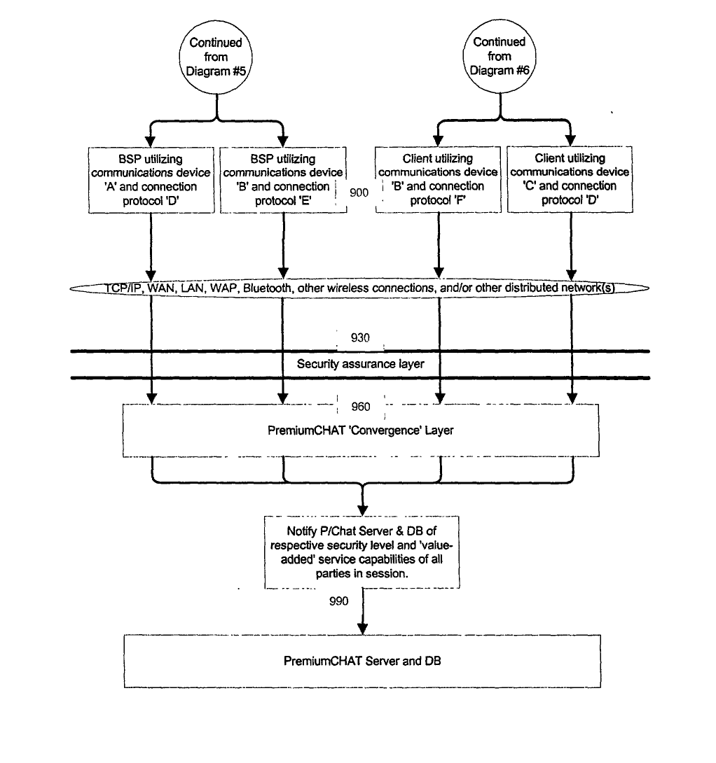

According to the present invention, communication between business service providers and clients is facilitated by a convergence layer (See FIG. 9) in a manner such that the business service provider and the client may communicate with one another utilizing different communications protocols and different devices. That is, the convergence layer communicates with each business service provider and each client independently and performs any necessary protocol conversion so as to function as a bridge between business service providers and clients. Thus, business service providers and clients are not constrained to utilizing the same type of device, i.e., a desktop or laptop computer, and are similarly not constrained to utilizing the same communication protocol.

The convergence layer further facilitates the use of different security protocols and/or value-added services capabilities between the business service provider and the client. The business service provider and the client may utilize the highest level of security which is common to both the business service provider and the client or may, alternatively, each utilize the highest security level of communications that is available to them alone, as long as the convergence layer of the present invention is capable of communicating using that highest security level. That is, the business service provider may communicate with the convergence layer utilizing the highest security level of communications that is available to both the business service provider and the convergence layer and similarly, and the client may communicate with the convergence layer utilizing the highest security level of communications that is available to both the client and the convergence layer. In this manner, the highest possible security and/or value-added services capabilities of all communications (taking into account the limitations of each participant) is achieved.

The convergence layer of the present invention facilitates the use of different devices by each business service provider and by each client. Thus, each business service provider and each client may independently (without respect to one another) utilize a desktop computer, a laptop computer, a palmtop computer, a cellular telephone, a pager, a wireless Internet access device, an Internet appliance, or a satellite network device, for example. Those skilled in the art will appreciate that various other communication devices are likewise suitable.

The method for facilitating negotiated fee-based communication session of the present invention facilitates negotiation of a rate at which the business service provider is to be paid by the client for consulting services and/or product(s) provided via the network. The negotiation process is typically an real-time iterative process wherein a plurality of offers and counter-offers are made until a rate is agreed upon. Once a rate is agreed upon, the rate is preferably displayed upon the screen of both participants (the business service provider and the client). Additionally, once a “billing” session has commenced, the current negotiated rate (taking into account the time elapsed during the consultation session and the billing rate) is displayed upon the screen of the business service provider and/or the client.

According to the preferred embodiment of the present invention, a client provides a credit card number and/or other payment mechanism(s) and the present invention checks to verify that sufficient credit remains on that credit card and/or other payment mechanism(s) for the client to pay the business service provider for some predetermined minimal amount of billing prior to initiating a negotiated fee-based communication session. The predetermined minimal amount of billing may either be for a fixed time increment, or may be for the entire or some portion of an estimated time for which a billed communication session is desired.

Similarly, the present invention optionally verifies that a business service provider has sufficient credit remaining on a deposit account with third party to pay the third party, e.g., PremiumChat, for a minimum number of billing sessions, security-levels, and/or value-added service capabilities available prior to initiating a negotiated fee-based communication. Each session may similarly be either fixed or may vary depending upon the selected level of security and/or value-added services selected.

Optionally, each business service provider is required to have a merchant account so as to facilitate payment of a client directly to the business service provider. Similarly, the third party may optionally have a merchant account so as to facilitate payment from each business service provider thereto.

During a billed communication session, either the business service provider or the client can typically initiate a value-added service. Generally, such value-added services will be provided for a predetermined fee which is paid by the initiation of said service. However, the business service provider and the client may alternatively negotiate a rate for one or more value added services. Such value added services typically comprise voice/audio/VoIP, multi-party audio conferencing, video, multi-party video conferencing, file transfer, language translation, currency conversion, and co-browsing, but may include other value-added services.

Optionally, renegotiation between a business service provider and a client is facilitated. This may occur, for example, when a client desires consultation or communication of a nature requiring a different billing rate than originally negotiated. For example, an attorney may have one billing rate for advice regarding incorporation and a different billing rate for advice regarding bankruptcy. Therefore, when the nature of the services and/or product(s) changes during a billing communication session, it is possible to halt the consultation process, and consequently halt billing, so as to facilitate renegotiation of the billing rate. Billing resumes when a new rate is agreed to and the new billing rate is applied.

Typically, billed communication sessions will be between a single business service provider and a single client. However, multi-conferencing (text, audio, video, or any other desired method) may be provided so as to facilitate multi-party communication wherein one or more business service providers provide consultation or communication to one or more clients. Thus, a plurality of business service providers may provide services and/or product(s) to a single client, a single business service provider may provide services and/or product(s) to a plurality of clients, or a plurality of business service providers may provide services to a plurality of clients. Those skilled in the art will appreciate that any desired combination of business service providers and clients may participate.

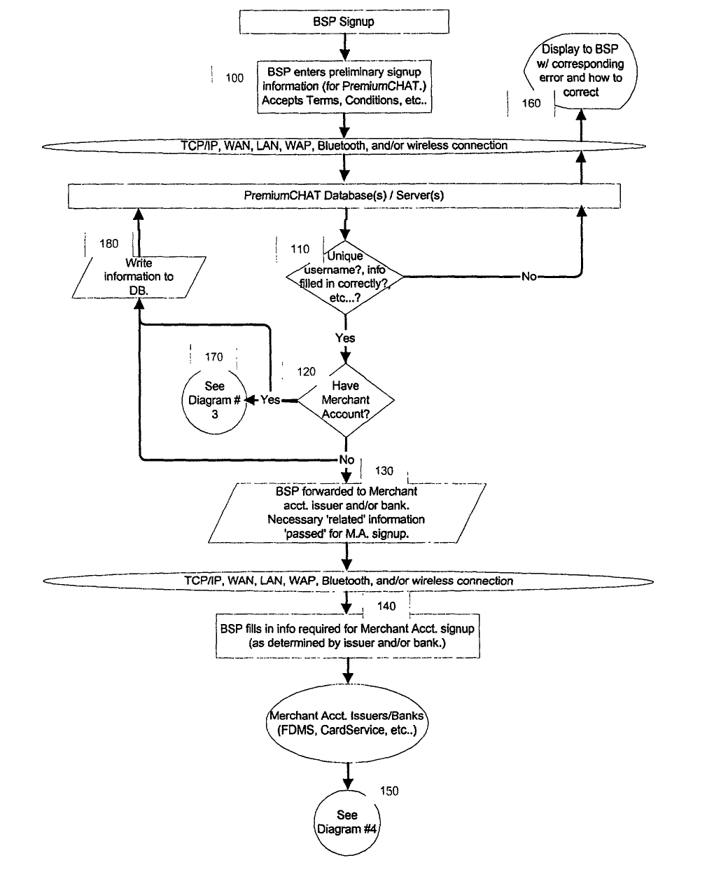

The method for facilitating negotiated fee-based communication on a network of the present invention is illustrated in FIGS. 1 through 19, which depict a presently preferred embodiment thereof. Each of these figures is discussed in detail below.

FIG. 1—Business Service Provider (BSP) Signup

100—Prospective BSP logs on to system to open a BSP account. User fills in appropriate business and personal information as identified by PremiumCHAT. (All information will be written to a ‘local’ database (for PremiumCHAT's own records) and the data then passed to Merchant Acct. Issuers/Financial Institutions/Banks specified URL for the Merchant Account signup (passing the data so user does not have to fill in information twice.)

110—Does prospective BSP have unique Username and/or password? All information filled in correctly?

Yes; Forward to 120

No; Forward to 160

120—Does user already have prior Merchant Account (M.A)?

Yes; Perform 180; Forward to 170

No; Perform 180; Forward to 130

130—Prospective BSP forwarded to Merchant Acct. Issuers/Financial Institutions/Banks specified URL for the Merchant Account signup. Data from initial signup ‘passed’ for M.A. signup.

140—Prospective BSP fills in info as required by M.A. issuer for M.A. signup.

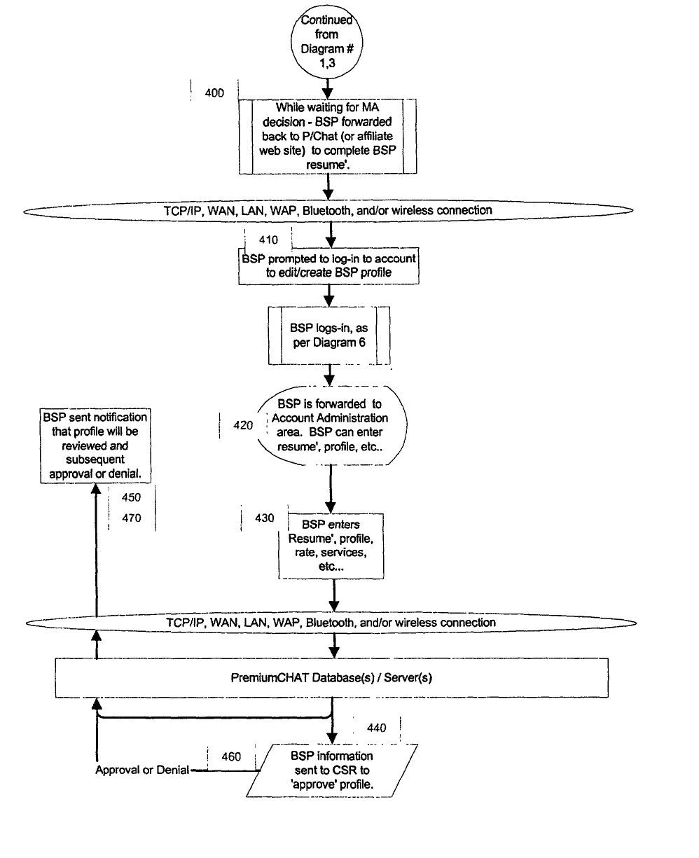

150—Forward to FIG. 4; 400

160—Notify prospective BSP of error in signup information and corresponding help on how to correct.

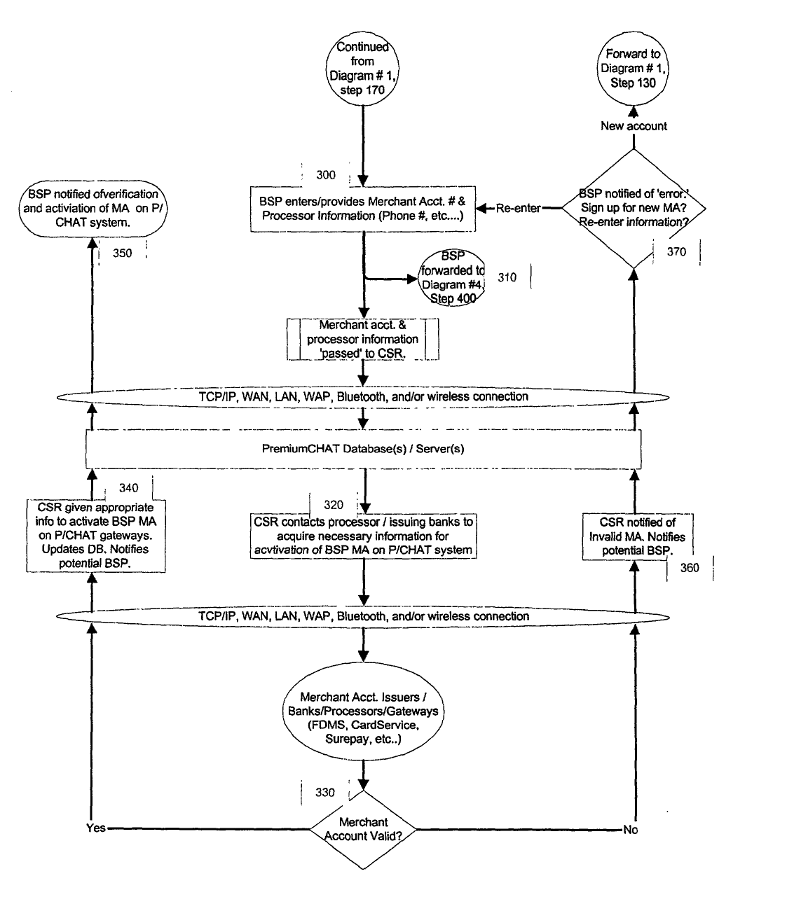

170—Forward to FIG. 3; 300

180—Write business and personal information, as identified by PremiumCHAT, to a Premium Chat database

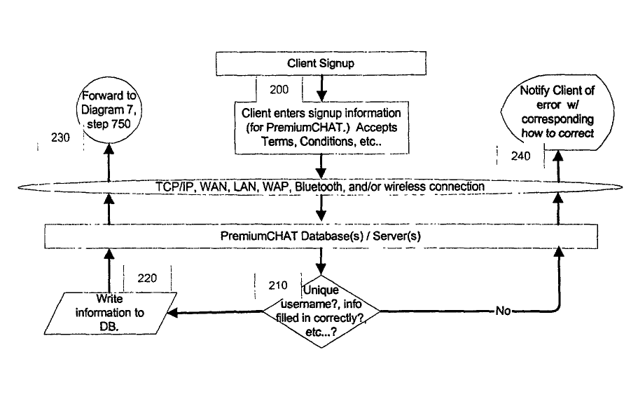

FIG. 2—Client Signup

200—Client logs on to system to open a client account. User fills in personal and payment mechanism (i.e. Credit Card, Debit Card) information (if applicable) as identified by PremiumCHAT.

210—Does prospective Client have unique Username and/or password? All information filled in correctly?

Yes; Forward to 220

No; Forward to 240

220—Write personal and payment mechanism (if applicable) information to a Premium Chat database.

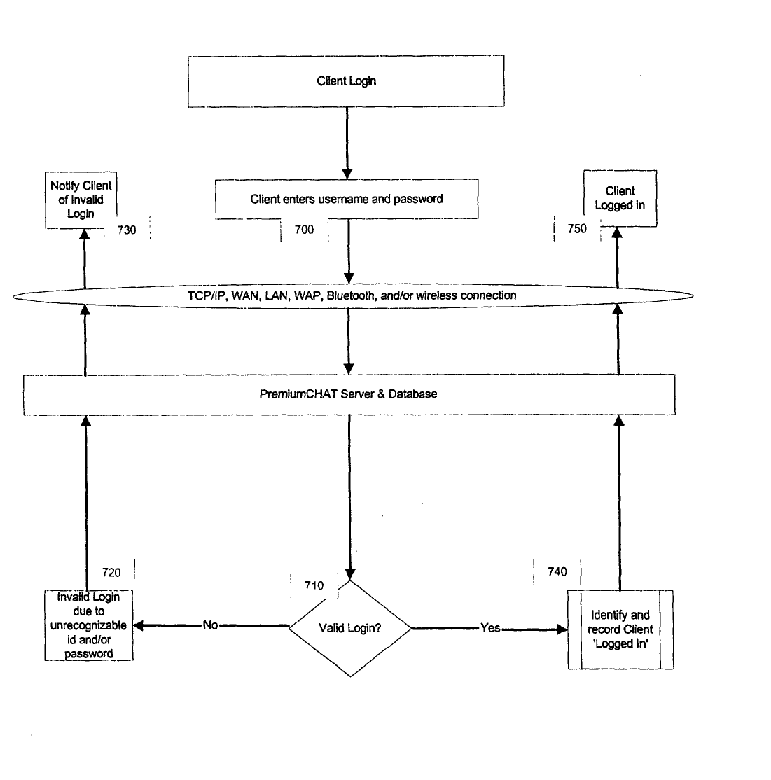

230—Forward new Client to FIG. 7; 750

240—Notify Client of error in signup information and corresponding help on how to correct.

FIG. 3—Existing Merchant Account Verification

300—Prospective BSP will provide existing Merchant Account information to Customer Service Rep.(CSR) (by means of e-mail, phone, fax, instant messaging, etc . . . —according to BSP preference)

310—After providing M.A. information, prospective BSP can be forwarded to FIG. 4; 400

320—CSR contacts processors/issuing banks/financial institutions to acquire necessary information for Premium Chat to activate prospective BSP M.A. on Premium Chat system & gateways.

330—Is Merchant Account information (as provided by BSP) ‘active’ and ‘valid’?

Yes; Forward to 340

No; Forward to 360

340—CSR given necessary information to activate BSP Merchant account for use on Premium Chat system & gateways.

350—BSP notified of verification and activation of M.A. on Premium Chat system.

360—CSR notified of ‘inactive’ or ‘invalid’ M.A. info; Prospective BSP notified.

370—BSP receives notification of error.

Re-enter information?; Back to 300

Sign-up for a new merchant acct.?; Back to FIG. 1; 130

FIG. 4—BSP Profile

400—BSP has option to enter to assemble complete BSP profile. (Includes resume', description of services, references, etc . . . . )

410—BSP prompted to Log-in (if not, presently)

420—BSP presented w/Account Administration area to complete profile and all related information.

430—BSP enters selected information.

440—BSP information forwarded for review to CSR.

450—BSP sent notification of receipt of profile.

460—CSR approves or denies BSP profile information based on Premium Chat criteria.

470—BSP sent notification of subsequent approval and/or denial of part/all of provided information.

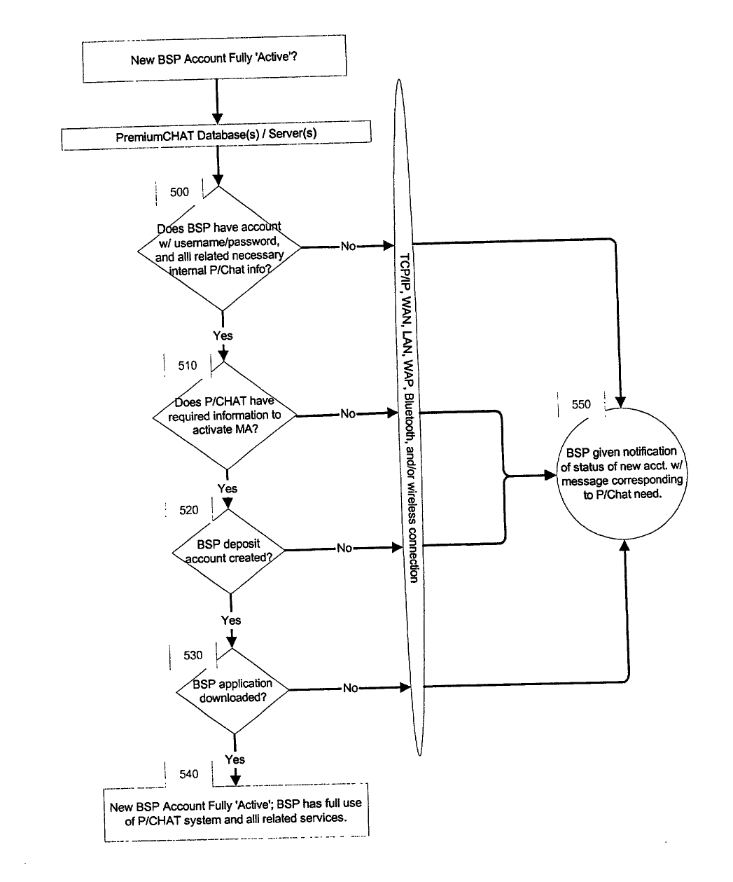

FIG. 5—BSP Account Activation

500—Does prospective BSP have account w/all related and necessary information for Premium Chat internal purposes?

Yes; Forward to 510

No, Forward to 550

510—Does Premium Chat have all required Merchant Account information for proper activation on Premium Chat system?

Yes; Forward to 520

No; Forward to 550

520—Does prospective BSP have a Premium Chat deposit account?

Yes; Forward to 520

No; Forward to 550

530—Has prospective BSP downloaded application?

Yes; Forward to 540

No; Forward to 550

540—New BSP Account fully ‘active.’ BSP has full use of Premium Chat system.

550—BSP given notification of status of prospective new acct. w/corresponding message highlighting Premium Chat needs for full ‘activation’ of prospective BSP account.

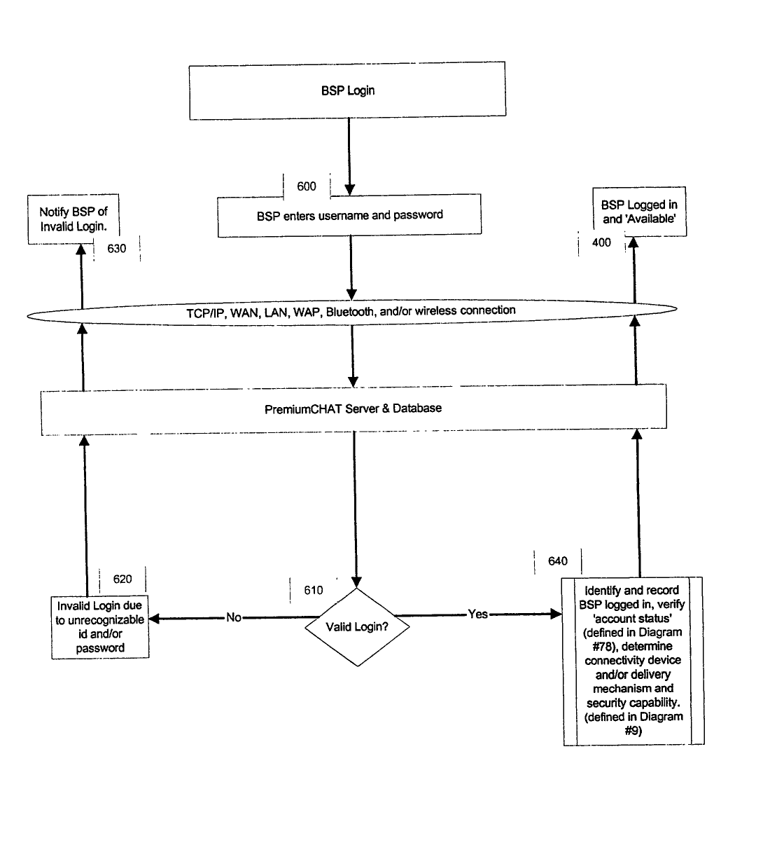

FIG. 6: BSP Login

600—BSP enters username and password (or other authentication mechanism, ie.—voice recognition, biometrics, etc . . . ) to log-in to PremiumCHAT servers via TCP/IP, LAN, WAN, PDA, Cell Phone, etc . . .

610—BSP username and password is verified against the appropriate PremiumCHAT database.

620—Invalid Login due to unrecognizable username and/or password

630—Invalid Login displayed to BSP. Try again?

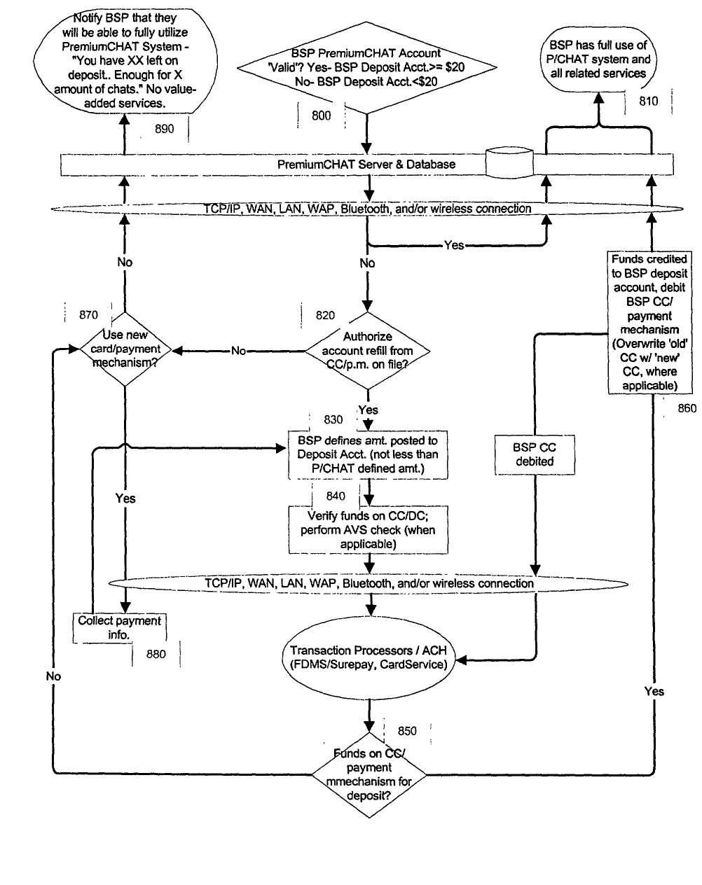

640—Login Valid; Identify and record to database BSP availability, ‘account status’ (‘Account’ status determined as per FIG. 8), ‘connectivity device, delivery mechanism and security capability of said mechanism and/or device’ (‘Connectivity device, delivery mechanism, and security capability determined as per FIG. 9)

650—BSP ‘Logged-in’ and ‘Available’

FIG. 7: Client Login

700—User/Client enters username and password (or other authentication mechanism, ie.—voice recognition, biometrics, etc . . . ) to log-in to PremiumCHAT servers via TCP/IP, LAN, WAN, PDA, Cell Phone, etc . . .

710—User/Client username and password is verified against the appropriate PremiumCHAT database.

720—Invalid Login due to unrecognizable username and/or password

730—Invalid Login displayed to Client. Try again?

740—Login Valid, record client ‘Logged In’

750—Client ‘Logged-in’ to PremiumCHAT system

FIG. 8: BSP Deposit Account Validation

800—The PremiumCHAT system verifies (w/the appropriate P/C database) that the BSP Deposit Account status is ‘Valid.’

Account status: ‘Valid’—defined by having greater than $20 (or some other defined dollar amount) in PremiumCHAT deposit account. Forward to step 810

Account Status: ‘Invalid’—defined by having less than or equal to $20 (or some other defined dollar amount) in PremiumCHAT deposit account. Forward to step 820

810—BSP Deposit Account status is ‘Valid’; BSP has full use of PremiumCHAT system and all related services and/or value-added services.

820—BSP Deposit Account status is ‘Invalid’; BSP will receive display / notification asking if PremiumCHAT can authorize Deposit account re-fill from Credit Card, Debit Card or payment mechanism possessed on file.

Yes; Forward to 830

No, Forward to 870

830—BSP has option to specify Deposit Account Maximum. However, Deposit Account maximum must be greater than or equal to $60 (or some other PremiumCHAT defined dollar amount.)

840—PremiumCHAT will verify availability of specified funds on BSP Credit Card, Debit Card, or other payment mechanism. (If ‘new’ CC or payment mechanism—perform Address Verification Check (or equivalent) to decrease fraudulent card use.)

850—After checking CC or DC with financial institutions/ACH, are funds available on BSP CC, DC, payment mechanism? (pass address verification check (or equivalent, if applicable.)

Funds available and pass address verification; Forward to 860

Funds not available and/or fail address verification, Forward to 870

860—Funds are available on CC or DC;

To PremiumCHAT database:

Credit specified amount (as determined in 830) to BSP ‘Deposit Account’

Overwrite ‘old’ CC,DC, or p.m. w/‘new’ CC, DC, or p.m. (where applicable if new card entered and/or requested by BSP)

To Financial Institution/Bank/ACH:

Debit BSP CC/DC/p.m. specified amount (as determined in 830)

870—Funds are not available on CC or DC, CC or DC failed Address verification check, or BSP Selects to use ‘new’ card; BSP will receive display/notification stating an error occurred (if applicable) and prompt for new CC or DC.

880—BSP is given display/notification and manually or verbally enters new CC information w/billing address or other related information needed to verify validity of CC.

890—BSP continues to decline to enter valid ‘new’ CC or DC to replenish Deposit Account; BSP will be given display/notification stating amount in deposit account and warning of possible ‘blocks’ on tiered service and security levels (as defined in 740) and ‘value-added’ service options.

FIG. 9—Convergence Layer

900—A BSP using a P.D.A. (communications device/mode ‘A’) and a wireless/Internet (WAP, Bluetooth) connection (connection protocol ‘D’) is ‘logged in’ and is entering into a negotiation session w/a potential Client who is ‘logged in’ and connected to the Internet via a desktop computer (communications device ‘B’) and using an ‘Instant Messaging’ system (ICQ, AIM, MSN Messenger, etc . . . )(connection protocol ‘B’).

930—The PremiumCHAT system will invariably have users w/different levels of security and or ‘value-added’ service capabilities dependent upon their respective means of connection and/or communications device(s). The Premium Chat security assurance layer is an imaginary line whereby PremiumCHAT, beginning at the ‘convergence layer’ will ensure the security w/in the system from beyond that point. The burden of providing security to the convergence layer is placed upon the connection devices and/or communications devices. Premium Chat assumes and ensures security at and beyond the convergence layer

960—Premium Chat convergence layer performs all actions as described in 930; Each device (adapter) will have its own specific delivery mechanisms (i.e.—different displays/notifications/capabilities dependent upon the device and/or the connection protocol (i.e. an Instant messaging service)); When using two different mediums and/or mode(s) of communication:

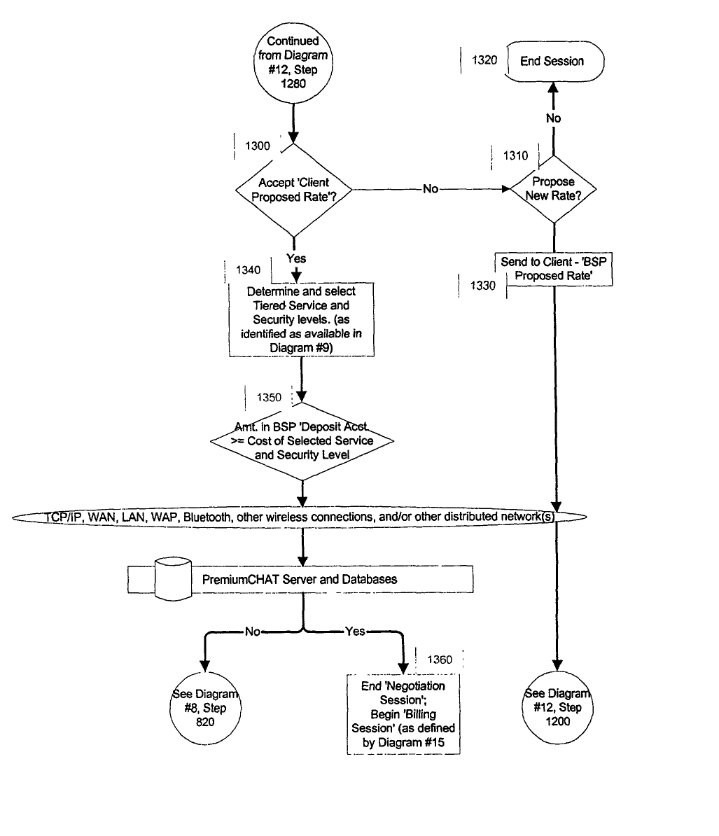

Least ‘secure’ ‘node’ is identified; tiered security level options (as defined in FIG. 13) enabled/disabled according to security capabilities of said nodes.

Least ‘capable’ ‘node’ of delivering value-added services identified and participants are restricted from performing said services as deemed ‘incapable’ because of ‘node’ restriction.

990—Premium Chat server/DB notified of respective security and value-added service capabilities of all parties involved in potential session.

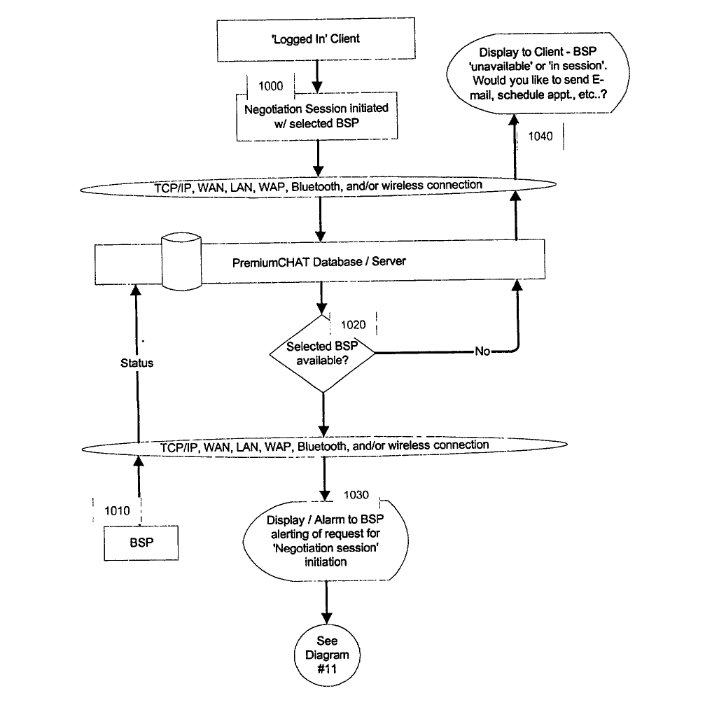

FIG. 10—Negotiation Session Initiation Request

1000—‘Logged-in’ Client initiates request for ‘Negotiation Session’ w/selected BSP.

1010—BSP availability is being reported to PremiumCHAT Database(s) & Server(s) via TCP/IP Connection ‘keep-alive’ and/or other connectivity verification mechanism.

1020—Is the selected BSP status ‘Available’?

Yes; forward to 430

No; forward to 440

1030—BSP status ‘Available’; Display/notification sent to selected BSP alerting him/her that Client has requested initiation of a ‘Negotiation session’. (Forward to 500)

1040—BSP status not ‘Available’; Display/notification to Client informing them that BSP is unavailable. Client given options to contact BSP by alternative means (i.e.—E-mail, schedule appointment, etc . . . )

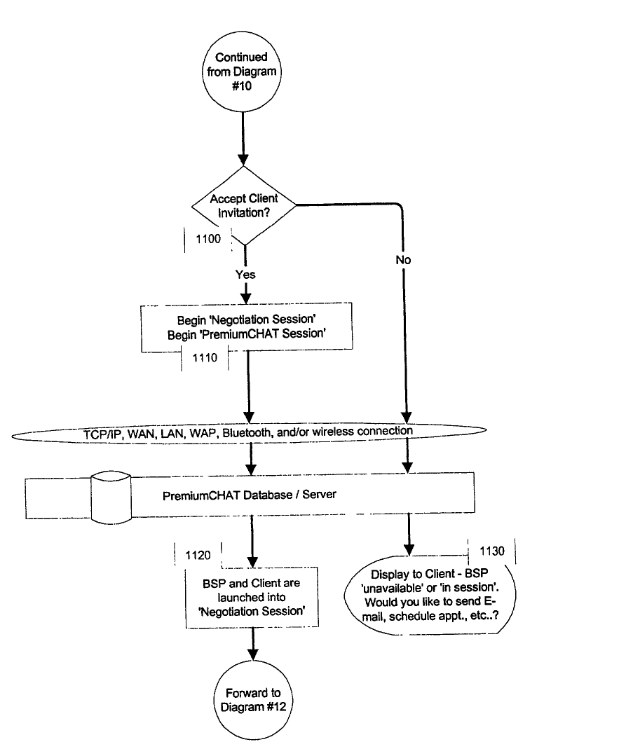

FIG. 11—Negotiation Session Acceptance

1100—BSP is prompted to enter ‘Negotiation session’. Accept Client invitation?

Yes; forward to 1110

No; forward to 1140

1110—Notify Premium Chat server—Begin ‘Negotiation Session’, ‘PremiumCHAT session’

1120—BSP and Client are launched into ‘Negotiation session’; forward to 1200

1130—Display/notification to Client informing them that BSP is currently unavailable. Client given options to contact BSP by alternative means (i.e.—E-mail, schedule appointment, etc . . . )

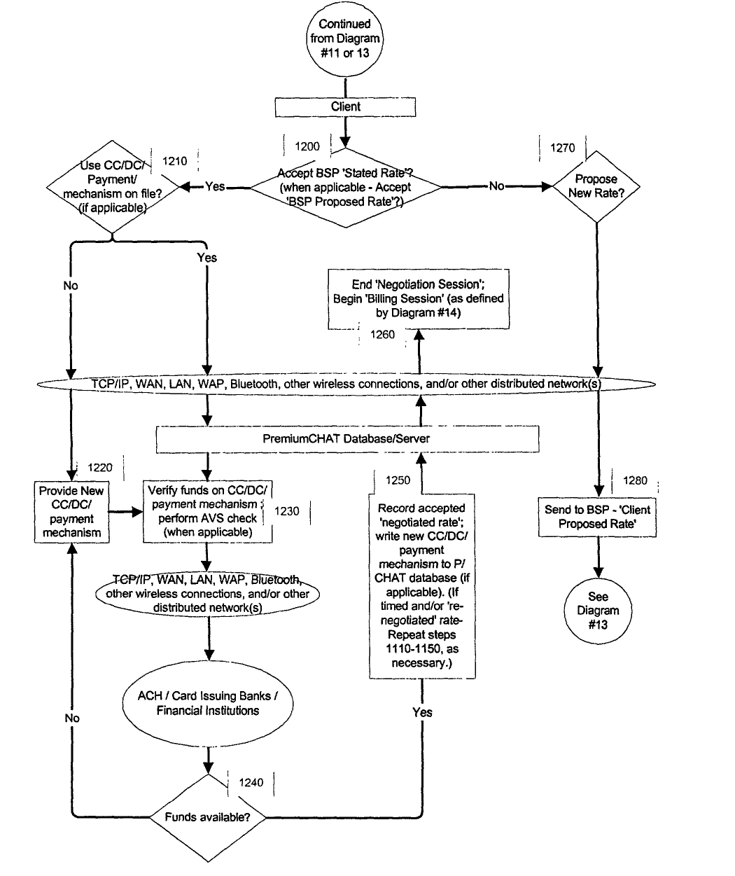

FIG. 12—Negotiation Session (a)

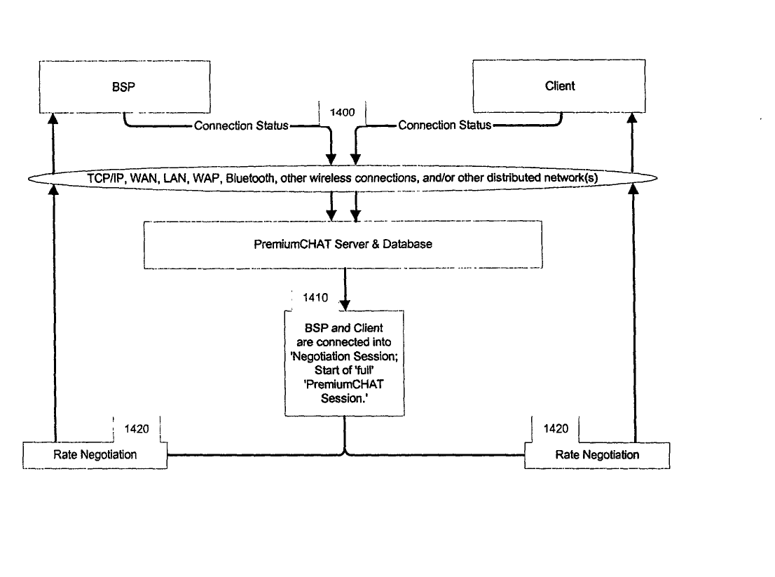

1200—While initially consulting w/BSP (as per FIG. 14; Rate proposals and bids are concurrent w/text or vocal communication throughout ‘Negotiation session’ or ‘Re-Negotiation Session’—to help determine true nature of services needed and gauge scope of project.)); Client has option of accepting BSP's ‘stated rate’ (as defined in FIG. 4); (or, when applicable, accepting BSP's ‘proposed rate’ (as defined in FIG. 13)

Accept, forward to 1210

Decline, forward to 1270

1210—Client is prompted w/option to use CC/DC/or other payment mechanism on file (PCHAT database(s) & server(s)).

Use CC/DC/p.m. on file, forward to 1300

No CC/DC/p.m. on file or do not use CC/DC/p.m. on file, forward to 630

1220—Client Selects to use ‘new’ card, CC/DC/p.m. failed Address verification check, or funds not available on Client CC/DC/p.m.; Client will receive display/notification stating an error occurred if applicable) and prompt for new CC/DC/p.m.

Client will also have option to determine if he/she wants CC/DC/p.m. for continued use (written to P/C database for easy re-use) or for one-time use only (not written to P/C database)

1230—PremiumCHAT, through ACH, financial institutions, etc . . . , will verify availability of specified funds on Client CC/DC/p.m.; If ‘new’ CC/DC/p.m., perform ‘Address Verification’ check to ensure validity of ‘new’ CC/DC/p.m. and decrease fraud.

1240—After checking CC or DC with financial institutions/ACH, are funds available on BSP CC/DC/p.m.?

Funds available and Address verification ‘passed’, forward to 1250

Funds not available and/or and Address verification ‘failed’, forward to 1220

1250—Funds are available on CC/DC/p.m. and Address verification ‘passed’ (when applicable); Write ‘new’ CC/DC/p.m. to database (if specified in 1220); Record accepted ‘negotiated’ rate; (If timed or ‘re-negotiated rate, repeat steps 1210-1250, as necessary)

1260—End ‘negotiation session’; spawn ‘billing session’ and all related uses and services inclusive.

1270—Client declination of BSP's ‘stated rate’; Client prompted to propose new rate.

1280—BSP is sent ‘Client proposed rate’. Forward to FIG. 13.

FIG. 13—Negotiation Session (b)

1300—While initially consulting w/client (as per FIG. 14; Rate proposals and bids are concurrent w/text or vocal communication throughout ‘Negotiation session’ or ‘Re-Negotiation Session’—to help determine true nature of services needed and gauge scope of project.)); BSP has option of accepting ‘Client proposed rate’ (as defined in FIG. 12)

Accept; forward to 1340

Decline; forward to 1310

1310—BSP declines ‘Client Proposed Rate.’ Propose ‘new rate’?

Yes; forward to 1330

No; forward to 1320

1320—End Negotiation Session

1330—Send to Client ‘BSP Proposed Rate.’ Forward to FIG. 12; 1200

1340—While client CC/DC/p.m. is being verified for available funds; BSP is presented w/selection of available ‘tiered’ security levels and ‘value-added’ services. (as identified as available in FIG. 9)

1350—BSP deposit account ‘valid’ for selected security and services?

Yes; forward to 1360

No; forward to FIG. 8; repeat steps 820-870, if applicable.

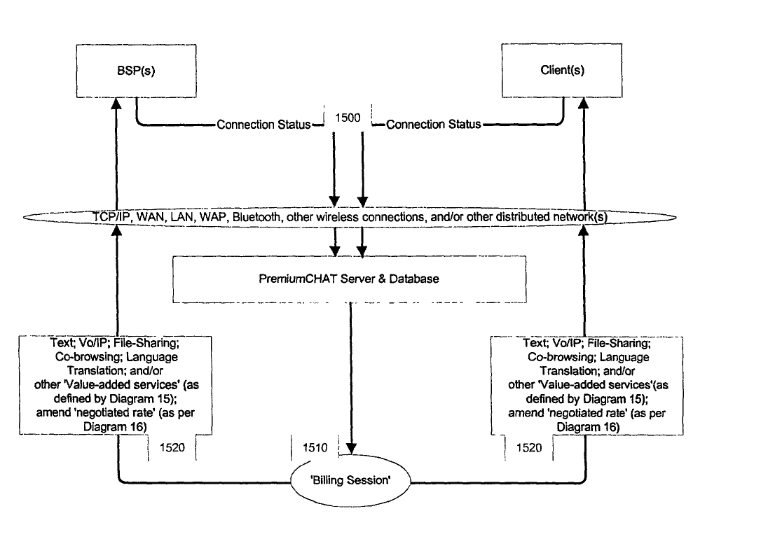

1360—End ‘negotiation session’; Begin ‘billing session’ (as defined by FIG. 15)

FIG. 14—Negotiation Session Overview

1400—BSP(s) and Client(s) connection status constantly updated to server/DB to ensure tracking accuracy.

1410—BSP(s) and Client(s) are connected in a ‘Negotiation Session’ via a distributed network and delivery mechanisms. (as determined by Convergence layer (FIG. 9))

1420—Rate proposals and/or bids are concurrent w/text or vocal communication throughout ‘Negotiation session’ or ‘Re-Negotiation Session’—to help determine true nature of services needed and gauge scope of project.

FIG. 15—Billing Session Overview

1500—BSP(s) and Client(s) connection status constantly updated to server/DB to ensure tracking, billing, and verification accuracy.

1510—BSP(s) and Client(s) are connected in a ‘billing session’ (under terms as determined by FIGS. 12,13) via a distributed network and delivery mechanisms. (as determined by Convergence layer (FIG. 9))

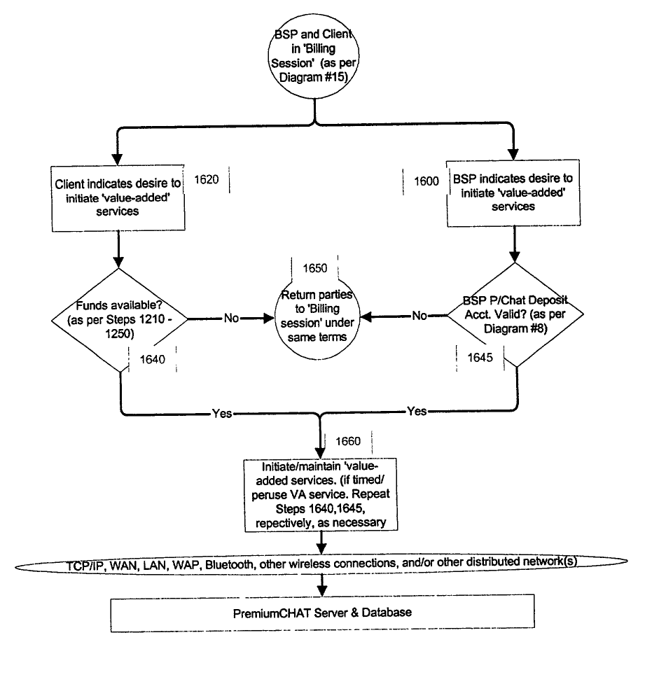

1520—BSP and client have capabilities (as identified by FIG. 9) for all ‘value-added’ service capabilities (as defined by FIG. 16); BSP and/or Client (after seeing true scope of project may ‘amend’ the agreed-to negotiated rate (as per FIG. 16)

FIG. 16—‘Value-Added Services’ Request

1600—BSP indicates desire to initiate specific ‘value-added’ services (as identified as available in FIG. 9).

1620—Client indicates desire to initiate specific ‘value-added’ services (as identified as available in FIG. 9).

1640—Client funds available for specified value-added services?

Yes; Forward to 1660

No; Forward to 1650

1645—BSP Deposit Account valid and available for specified value-added services?

Yes; Forward to 1660

No; Forward to 1650

1650—Return parties to ‘billing session’ under previous terms.

1660—Initiate/maintain selected Value-added services. (if timed or per-use service—repeat steps 1640, 1645; respectively, as necessary.

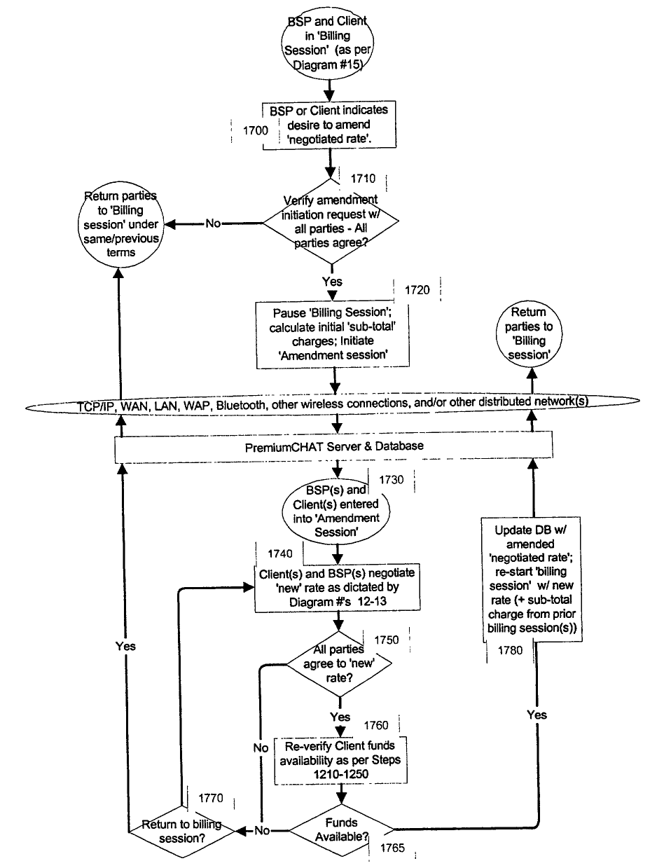

FIG. 17—Negotiated Rate Amendment

1700—BSP or Client indicates desire to amend ‘negotiated rate’.

1710—Verify amendment initiation request w/all parties—All parties agree?

Yes; forward to 1720

No; Return parties to billing session; as per 1650

1720—Pause ‘Billing Session’; calculate initial ‘sub-total’ charges; Initiate ‘Amendment session’

1730—BSP(s) and Client(s) entered into ‘Amendment Session’

1740—Client(s) and BSP(s) negotiate ‘new’ rate as dictated by FIGS. 12-13

1750—All parties agree to amended negotiated rate?

Yes; forward to 1760

No; forward to 1770

1760—Re-verify Client(s) funds availability as per Steps 1210-1250

1765—Funds Available?

Yes; forward to 1780

No; forward to 1770

1770—Return to billing session under previous/unchanged terms?

Yes; Return parties to billing session; as per 1650

No; Back to 1640

1780—Update DB w/amended ‘negotiated rate’; re-start ‘billing session’ w/new rate (+sub-total charge from prior billing session(s))

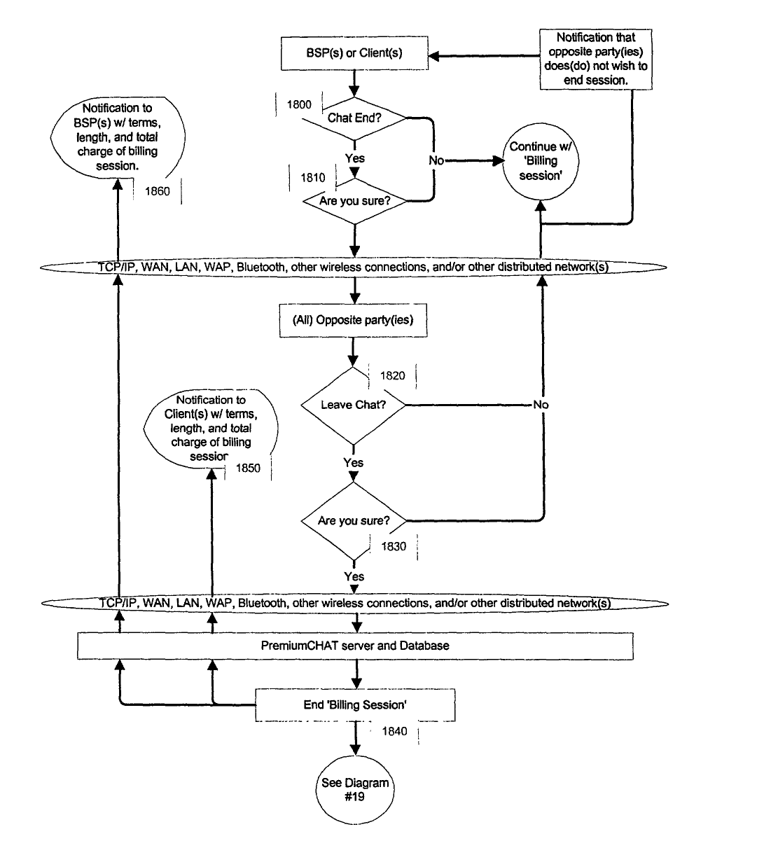

FIG. 18—End Billing Session (a)

1800—BSP(s) and/or Client(s) indicate desire to end billing session. End billing session?

Yes; Return parties to billing session; as per 1650

No; Forward to 1810

1810—Double-check billing session termination request. Are you sure?

Yes; Forward to 1820

No; Return parties to billing session; as per 1650

1820—Ask primary opposite party. Verify end billing session request?

Yes; Forward to 1830

No; Return parties to billing session; as per 1650

1830—Double-check billing session termination verification. Are you sure?

Yes; Forward to 1840

No; Return parties to billing session; as per 1650

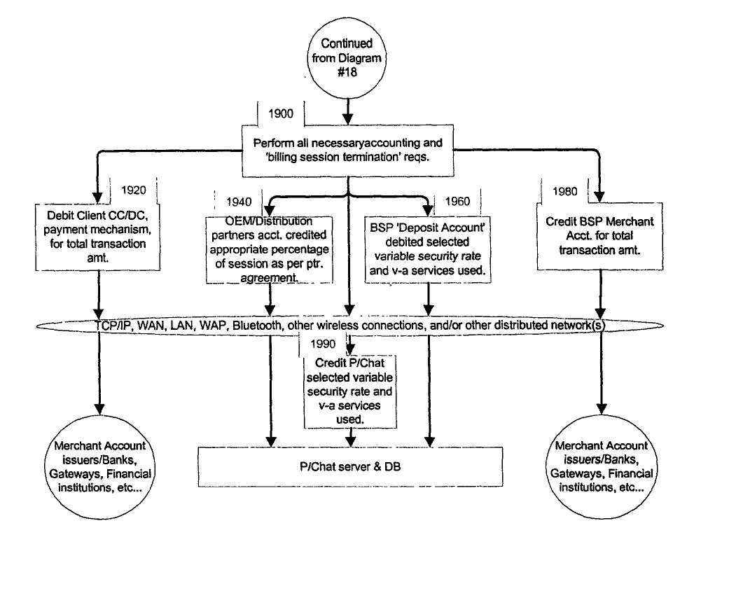

1840—End Billing session; forward to FIG. 19

1850—Notification to Client(s) w/terms, length, and total charge of billing session.

1860—Notification to BSP(s) w/terms, length, and total charge of billing session.

FIG. 19—End Billing Session (b)

1900—Perform all necessary accounting and ‘billing session termination’ reqs.

1920—Debit Client CC/DC, payment mechanism, for total transaction amt.

1940—OEM/Distribution partners acct. credited appropriate percentage of session as per partner agreement.

1960—BSP ‘Deposit Account’ debited selected variable security rate and v-a services used.

1980—Credit BSP Merchant Acct. for total transaction amt.

1990—Credit Premium Chat selected variable security rate and v-a services used throughout billing session.

1. A method for a third party facilitating fee based consultation on a network, the method comprising:
forming a business relationship between the third party and a plurality of business service providers;
facilitating communication between the business service providers and clients of the business service providers via the network;
facilitating negotiation between the business service provides and the clients for a time based consulting fee; and
facilitating automatic billing of the client and automatic payment of the business service provider for a consultation.

2. The method as recited in claim 1, wherein forming a business relationship comprises the business service provider providing money for a deposit account from which money is removable by the third party as payment for facilitating the fee based consultation.

3. The method as recited in claim 1, wherein facilitating communication between the business service providers and the clients comprises facilitating communication on the Internet.

4. The method as recited in claim 1, wherein facilitating communication between the business service providers and the clients comprises facilitating communication between business service providers and clients which use different communications protocols with respect to one another.

5. The method as recited in claim 1, wherein facilitating communication between the business service providers and the clients comprises facilitating communication between business service providers and clients which use different communications devices with respect to one another.

6. The method as recited in claim 1, wherein facilitating communication between the business service providers and clients comprises facilitating communication between business service providers and clients, each of which uses a device selected independently from the list consisting of:
desktop computer;
laptop computer;
palmtop computer;
cellular telephone;
pager;
wireless internet access device;
Internet appliance; and
satellite network device.

7. The method as recited in claim 1, wherein facilitating communication between the business service providers and the clients comprises facilitating secure communication between business service providers and the clients.

8. The method as recited in claim 1, wherein facilitating communication between the business service providers and the clients comprises facilitating secure communication between the business service providers and the clients and wherein a level of security has been determine by at least one of a business service provider and a client.

9. The method as recited in claim 1, wherein facilitating communication between the business service providers and the clients comprises facilitating secure communication between the business service providers and the clients and wherein security protocols used by the business service provider and the client are different with respect to one another.

10. The method as recited in claim 1, wherein facilitating communication between the business service providers and the clients comprises facilitating secure communication between the business service providers and the clients and wherein the level of security between each business service provider and each client is the most secure security level common to both the business service provider and the client.

11. The method as recited in claim 1, wherein facilitating communication between the business service providers and the clients comprises facilitating secure communication between the business service providers and the clients via the third party and wherein the level of security used by each business service provider is the most secure security level common to both the business service provider and the third party and wherein the level of security used by each client is the most secure security level common to both the client and the third party.

12. The method as recited in claim 1, wherein facilitating negotiation between the business service providers and the clients comprises facilitating negotiation of a rate at which the business service provider is to be paid by the client for consulting services provided via the network.

13. The method as recited in claim 1, wherein facilitating negotiation between the business service providers and the clients comprises an iterative process of offer and counter offer until a rate is agreed upon.

14. The method as recited in claim 1, further comprising displaying a counter to at least one of the business service provider and the client, the counter showing an incrementing dollar value which is an amount billed by the business service provider to the client at a negotiated rate.

15. The method as recited in claim 1, further comprising verifying that a client has sufficient credit remaining on a credit card to pay the business service provider for a minimum billing time prior to initiating a fee based consultation.

16. The method as recited in claim 1, further comprising verifying that a business service provider has sufficient credit remaining on a credit card to pay the third party for a minimum billing time prior to initiating a fee based consultation.

17. The method as recited in claim 1, wherein each of the business service providers have a merchant account for facilitating payment of a client to a business service provider.

18. The method as recited in claim 1, wherein each of the business service providers has a merchant account and the merchant account of a business service provider is credited for at least one minimum time increment prior to the business service provider providing a business service for that time increment.

19. The method as recited in claim 1, wherein each of the business service providers has a merchant account and the merchant account of a business service provider is credited each time increment prior to the business service provider providing a business service for that time increment.

20. The method as recited in claim 1, wherein the third party has a merchant account.

21. The method as recited in claim 1, wherein the third party has a merchant account and the merchant account of the third party is credited for each time increment prior to the third part facilitating fee based consultation between a business service provider and a client.

22. The method as recited in claim 1, wherein either the business service provider or the client can initiate a value added service during a fee base consultation.

23. The method as recited in claim 1, wherein either the business service provider or the client can initiate a value added service during a fee base consultation, the value added service being selected from the group consisting of:
voice/audio/VoIP;
multi-party audio conferencing;
video;
multi-party video conferencing;
file transfer;
language translation;
currency conversion; and
co-browsing.

24. The method as recited in claim 1, wherein the business service provider and the client negotiate for payment for a value added service during a fee base consultation.

25. The method as recited in claim 1, wherein the business service provider and the client negotiate for payment a value added service during a fee base consultation, the value added service being selected from the group consisting of:
voice/audio/VoIP;
multi-party audio conferencing;
video;
multi-party video conferencing;
file transfer;
language translation;
currency conversion; and
co-browsing.

26. The method as recited in claim 1, further comprising enabling at least one value added service during the negotiation.

27. The method as recited in claim 1, further comprising facilitating re-negotiation between a business service provider and a client.

28. The method as recited in claim 1, further comprising facilitating suspending a fee based consultation and later resuming the fee based consultation, such that the client is not billed for the time during which the fee based consultation is suspended.

29. The method as recited in claim 1, further comprising facilitating suspension of the fee based negotiation and re-negotiation of the rate between a business service provider and a client during the suspension.

30. The method as recited in claim 1, wherein fee based consultation between a plurality of business service providers and a single client is facilitated.

31. The method as recited in claim 1, wherein fee based consultation between a single business service provider and a plurality of clients is facilitated.

32. The method as recited in claim 1, wherein fee based consultation between a plurality of business service providers and a plurality of clients is facilitated.

33. A method for facilitating fee-based, on-line consulting, the method comprising:
selecting a consultant on-line; negotiating a consulting payment rate on-line;
consulting on-line;
timing a duration of the consulting; and
billing the client for the consultation.

34. The method as recited in claim 33, wherein selecting a consultant on-line comprises:
reviewing a list of prospective consultants; and
selecting the desired consultant from the list.

35. The method as recited in claim 33, wherein selecting a consultant comprises:
selecting a category of the consultant;
reviewing a list of prospective consultants within the selected category; and
selecting the desired consultant from the list.

36. The method as recited in claim 33, wherein selecting a consultant comprises:
selecting a category of the consultant;
selecting a sub-category of the consultant;
reviewing a list of prospective consultants within the selected sub-category; and
selecting the desired consultant from the list.

37. The method as recited in claim 33, wherein timing the duration of the consulting comprises timing the duration of the consulting using a predetermined time increment.

38. The method as recited in claim 33, wherein timing the duration of the consulting comprises timing the duration of the consulting using a predetermined time increment of approximately 0.1 hour.

39. The method as recited in claim 33, wherein timing the duration of the consulting comprises timing the duration of the consulting using a time increment which has been agreed upon by both a client and a consultant.

40. The method as recited in claim 33, wherein selecting a consultant on-line is performed by a client.

41. The method as recited in claim 33, wherein billing the client is performed by software.

42. The method as recited in claim 33, wherein billing the client comprises billing a credit card of the client.
performed by consultant

43. A method for use by a professional to facilitate fee-based, on-line consulting, the method comprising:
downloading software;
entering billing information via the software;
negotiating a consulting payment rate with a client on-line;
consulting with a client;
timing a duration of the consulting;
and billing the client via the software.

44. The method as recited in claim 43, wherein downloading software comprises downloading software from a web page.

45. The method as recited in claim 43, further comprising registering the software.

46. The method as recited in claim 43, further comprising registering the software, wherein registering the software comprises applying for a merchant account.

47. The method as recited in claim 43, further comprising paying a deposit.

48. The method as recited in claim 43, further comprising paying a deposit via a credit card.

49. The method as recited in claim 43, further comprising paying a per use fee for the software.

50. The method as recited in claim 43, further comprising paying a per use fee for the software by deducting the per use fee from a deposit.

51. The method as recited in claim 43, further comprising indicating that the professional is available for on-line consultation.

52. The method as recited in claim 43, wherein timing the duration of the consulting comprises timing the duration of the consulting using a predetermined time increment.

53. The method as recited in claim 43, wherein timing the duration of the consulting comprises timing the duration of the consulting using a predetermined time increment of approximately 0.1 hour.

54. The method as recited in claim 43, wherein timing the duration of the consulting comprises timing the duration of the consulting using a time increment which has been agreed upon by both a client and a consultant.

55. The method as recited in claim 43, wherein billing the client is performed by software.

56. The method as recited in claim 43, wherein billing the client comprises billing a credit of the client.
performed by client

57. A system for use by a client to facilitate fee-based, on-line consulting, the system comprising:
a computer configured to faciliate:
selecting a consultant on-line;
negotiating a consulting payment rate on-line; and
participating in a consulting session on-line.

58. The system as recited in claim 57, wherein the computer is further configured to facilitate:
reviewing a list of prospective consultants; and
selecting the desired consultant from the list.

59. The system as recited in claim 57, wherein the computer is further configured to facilitate:
selecting a category of the consultant;
reviewing a list of prospective consultants within the selected category; and
selecting the desired consultant from the list.

60. The system as recited in claim 57, wherein the computer is further configured to facilitate:
selecting a category of the consultant;
selecting a sub-category of the consultant;
reviewing a list of prospective consultants within the selected sub-category; and
selecting the desired consultant from the list.
